(19) United States
(12) Patent Application Publication
(10) Pub. No.: US 2006/0009149 A1
(43) Pub. Date: Jan. 12, 2006

(54) Regulating access rates in a radio communication system

(75) Inventors: Andreas Baessler, Peterhausen (DE); Ingo Gruber, Planegg (DE); Hui Li, Beijing (CN)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 11/131,323

(22) Filed: May 18, 2005

(30) Foreign Application Priority Data
May 18, 2004 (DE) 10 2004 024 647.5

(51) Int. Cl. H04H 1/00

(52) U.S. Cl. 455/3.01

(57) ABSTRACT

In a radio communication system which incorporates numerous radio stations, messages are transmitted along a path from a first radio station to a second radio station via one or more radio stations which forward the messages. At least one radio station on the path sends a first signaling message to the radio station which is neighboring to it along the path towards the first radio station. This signaling message contains data about the maximum transmission resource access rate to be used for sending messages to the one or more radio station.

### CROSS REFERENCE TO RELATED APPLICATIONS

This application is based on and hereby claims priority to German Application No. 10 2004 024 647.5, filed on May 18, 2004, the contents of which are hereby incorporated by reference.

### BACKGROUND OF THE INVENTION

1. Field of the Invention

The invention relates to communicating by radio to transmit messages along a path from a first to a second radio station via one or more radio stations which forward the messages.

2. Description of the Related Art

In radio communication systems, messages which contain for example voice data, image data, video data, SMS (Short Message Service), MMS (Multimedia Messaging Service) or other data, are transmitted with the help of electromagnetic waves over a radio interface, between the sending and the receiving radio station. Depending on the specific embodiment of the radio communication system, the radio stations in this situation can be various types of subscriber-side radio stations, repeaters, radio access points or base stations. In a mobile radio communication system, at least some of the subscriber-side radio stations are mobile radio stations. The electromagnetic waves are emitted with carrier frequencies which lie within the frequency band provided for the system concerned.

Mobile radio communication system are frequently designed as cellular systems, e.g. in accordance with the GSM (Global System for Mobile Communication) or UMTS (Universal Mobile Telecommunications System) standard, with a network infrastructure consisting, for example, of base stations, devices for checking and controlling the base stations and other network-side devices. Apart from these cellular hierarchical radio networks, organized on a wide-area (supra-local) basis, there are also wireless local networks (WLANs, wireless local area networks) which generally have a significantly more restricted radio coverage area. The cells covered from the radio access points (APs) of WLANs, which generally have a diameter of up to a few hundred meters, are small compared to the usual mobile radio cells. Examples of different standards for WLANs are HiperLAN, DECT, IEEE 802.11, Bluetooth and WATM.

Radio stations can then only communicate directly with each other if each is located within the radio coverage area of the other. If direct communication is not possible, then messages can be transmitted between the radio stations concerned via other radio stations which—in that they forward the messages—act as relay radio stations. Depending on the specific embodiment of the radio communication system, it is possible for such message forwarding to be carried out by both the subscriber radio stations and also by the network-side radio stations. It is possible for messages in a WLAN, for example, to be forwarded between a radio access point and a subscriber radio station far away from the radio access point. Through the WLAN radio access point, it is possible to effect the connection of subscriber radio stations to other communication systems, such as for example to the Internet. It is also possible, in a radio communication system's ad-hoc mode, for subscriber radio stations to communicate with each other via one or more steps (a hop or multihop) without any switching devices, such as for example base stations or radio access points, being included in the circuit. In this case, when messages are transmitted from one subscriber radio station to another outside the radio coverage area of the first, the messages are forwarded by other subscriber radio stations, which thus act as relay radio stations.

In such a radio communication system, in which radio transmissions are based on the forwarding of messages by radio stations, if there is no central instance which assigns to individual radio stations the radio resources for the sending or forwarding of messages, as applicable, then the system can become clogged up or overloaded due to an excessive number of messages being sent or the uncoordinated sending of messages, so that ultimately messages which are to be forwarded are instead discarded.

### SUMMARY OF THE INVENTION

An object of the invention is to demonstrate an improved method for radio communication, which gets round the problem described above.

According to an aspect of the invention, messages are transmitted over a path from a first to a second radio station via one or more radio stations which forward the messages. At least one radio station on the path transmits a first signaling message to the radio station which is neighboring to it along the path and in the direction of the first radio station. This first signaling message contains data about a maximum transmission resource access rate which may be used at the one or more radio stations.

At least some of the radio stations may be, in particular, mobile subscriber radio stations. As components of a WLAN, for example, or also in the context of an ad-hoc mode for a cellular system or a WLAN, these can communicate with each other in the course of message forwarding without any involvement of devices on the network side.

Messages are transmitted over a path between a first and a second radio station. In this situation, the radio stations on the path are the first radio station, the forwarding radio stations and the second radio station. The transmission of each message over the path takes place between neighboring radio stations, where two radio stations are neighboring if each of them is located within the radio coverage area of the other. Each radio station on the path, with the exception of the first and the second radio station, thus has two neighboring radio stations on the path, one in the direction of the first radio station and one in the direction of the second radio station.

At least one radio station on the path transmits a first signaling message to a radio station which is neighboring to it and which is in the direction of the first radio station, as seen from the one or more radio stations on the sub-path. This neighboring radio station could, where appropriate, also be the first radio station. The first signaling message relates to a maximum transmission resource access rate which may be used. The transmission resource access rate specifies how often a radio station accesses the transmission medium per time unit. The maximum access rate to be used indicates, to the radio station which is addressed, the maximum frequency with which it may access the transmission medium. The radio station which receives the first signaling message can then adjust its access rate such that it corresponds to the maximum access rate which may be used, or is less than this or does not exceed it, as applicable. The access rate can be set using methods which are known per se.

It is advantageous if the method described, of sending the first signaling message, is performed by not only one radio station on the path but by several or all the radio stations on the path, except for the first radio station which has no neighboring radio station on the same side as the first radio station.

In a development of the invention, before the first signal message is sent, each of the one or more radio stations receives, from the radio station neighboring to it along the path in the direction of the first radio station, a second signaling message with data about the transmission resource access rate which is currently being used by the radio station neighboring to it along the path in the direction of the first radio station, for sending the message to the one or more radio stations. This second signaling message can be a component of a data packet which, for example, contains user data which, regardless of the second signaling message, is to be sent from the radio station concerned.

It is advantageous if the one or more radio stations determine the maximum transmission resource access rate to be used from the data in the second signaling message and from the number of messages to be forwarded by it and the number of its own messages to be sent. The one or more radio stations thus receive the second signaling message from a radio station neighboring to them, and using the content of the second signaling message determine a maximum access rate which the radio station that sent the second signaling message may use. Another factor which goes into the determination of the maximum access rate to be used is the number of its own messages to be sent by the one or more radio stations. These are messages which have not been received by the one or more radio stations for forwarding, but rather are messages for which the original transmitter is the one or more radio stations.

In one embodiment of the invention, the one or more radio station transmits a third signaling message, to the radio station neighboring to it along the path towards the second radio station, with data about the transmission resource access rate which it is currently using for sending messages to the radio station neighboring to it along the path towards the first radio station. In this case, the one or more radio station transmits to its neighboring radio station towards the first radio station a message about the maximum access rate it should use, in the form of a first signaling message, and to its neighboring radio station towards the second radio station data about the access rates it is itself currently using, in the form of a third signaling message. It is advantageous if the one or more radio station determines the transmission resource access rate it is currently using for sending messages to its neighboring radio station, along the path towards the second radio station, from the data in the second signaling message, and from the number of messages which it is to forward and the number of its own messages which are to be sent.

In one embodiment of the invention, the first signaling message incorporates a confirmation of receipt for a message received by the one or more radio stations from its neighboring radio station along the path in the direction of the first radio station. Combining the data about the maximum access rate to be used and the confirmation of receipt in one message is advantageous for systems in which messages which are received are always answered by confirmation messages. It is advantageous, in particular, if the first signaling message contains a confirmation of receipt for the second signaling message.

In one embodiment of the invention, after it has received the first signaling message the radio station which is neighboring to the one or more radio stations towards the first radio station along the path transmits, to the radio station which is neighboring to it along the path towards the first radio station, a fourth signaling message with data about the maximum transmission resource access rate to be used for the sending of messages. This access rate, contained in the fourth signaling message can, in particular, be determined from the access rate contained in the first signaling message. It is possible in this way for instructions, about the maximum rates to be used, to be forwarded along the entire path from the second radio station through to the first radio station.

The radio station in accordance with the invention has facilities for forwarding messages which are transmitted over a path from a first to a second radio station via the radio station and, where applicable, via one or more additional radio stations which forward the messages. In accordance with the invention, it incorporates facilities for generating and sending to the radio station which neighbors it along the path towards the first radio station a signaling message with data about the maximum transmission resource access rate to be used for sending messages to the radio station.

The radio station in accordance with the invention is suitable, in particular, for carrying out the method in accordance with the invention, and this also applies to the embodiments and developments. It can have further suitable facilities for this purpose.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a flow diagram of the method in accordance with the invention,

FIG. 2 is a block diagram of a radio station in accordance with the invention.

### DETAILED DESCRIPTION OF THE PREFERRED EMBODIMENT

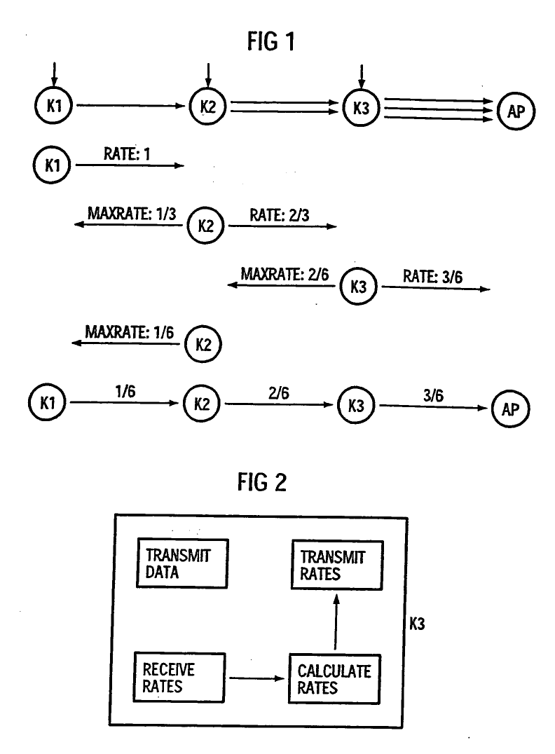

In what follows, a WLAN radio communication system is considered. Data packets are transmitted between a radio access point AP and the radio stations K1, K2 and K3, by the data packets being forwarded through radio stations as necessary. The top part of FIG. 1 shows the data packets to be sent per unit time, each being represented by a single arrow. In the case of a message transmission from the radio station K1 to the radio access point AP, the radio stations K2 and K3 act as relay stations. A data packet generated by the radio station K1, indicated by an arrow pointing towards the radio station K1, is sent by radio station K1 to the radio station K2, from where it is forwarded to the radio station K3, and from there on to the radio access point AP. As a result there is a path for the transmission of messages between the radio station K1 and the radio access point AP, the components of this path being the radio stations K1, K2, K3 and AP. The radio station K1 can be a subscriber station, and the radio stations K2 and K3 can be subscriber stations or network-side relay stations or repeaters, as appropriate.

In addition to forwarding the data packets which originate from the radio station K1, the radio station K2 also sends a data packet of its own, indicated by an arrow pointing towards the radio station K2, which is to be forwarded to the radio access point AP. There are thus two data packets to be sent by the radio station K2, indicated by two outgoing arrows. Radio station K3 forwards both of the data packets received from radio station K2. In addition, the radio station K3 sends a data packet of its own, indicated by an arrow pointing towards the radio station K1, to the radio access point AP, so that there are three data packets to be sent by the radio station K3, indicated by three outgoing arrows. As the radio access point AP enables the radio stations K, K2 and K3 to access other communication networks, such as for example the Internet, numerous data packets are directed to the radio access point AP, so that the number of data packets to be sent by a radio station increases the nearer the radio station is to the radio access point AP. This applies in principle for the transmission of messages away from the radio access point AP and also towards the radio access point AP, with FIG. 1 showing only the transmission of messages towards the radio access point AP. In terms of message transmissions, systems with numerous subscriber radio stations and one radio access point thus have a star-shaped network topology.

As shown in the top line of FIG. 1, six message transmissions should take place per time unit. Here, it is assumed that the rates at which the radio stations K1, K2 and K3 generate data packets of their own are roughly the same. For each time unit in FIG. 1, each of the three radio stations K1, K2 and K3 generates one data packet of its own. Hence, per time unit the radio station K1 must only send its own data packet, while the radio station K2 must send one data packet of its own and one which is to be forwarded, and radio station K3 must send one data packet of its own and two which are to be forwarded.

The radio stations K1, K2, K3 and AP use only one radio frequency for sending and forwarding messages, so that if several radio stations send them at the same time interference can occur. Thus it is impossible for radio station K1 to successfully send a data packet to radio station K2 while the radio station K3 is at the same time sending a data packet to the radio access point AP. The radio waves with the same frequency interfere at the site of radio station K2, so that the latter cannot successfully receive the data packet from radio station K1.

Under the IEEE 802.11b standard, the transmission resources are accessed using a CSMA/CA (Carrier Sense Multiple Access/Collision Avoidance) method. In this case, if a radio station categorizes the transmission medium according to a prescribed method as unoccupied, it may then access the medium by sending a message. If a method of this type is applied to the message transmission in FIG. 1 there is a problem, that the further radio station is away from the radio access point AP, the more often it will categorize the transmission medium as unoccupied, due to the star-shaped topology. Consequently, numerous messages will be sent from these radio stations towards the radio access point AP. However, as the radio stations on the path towards the radio access point AP not only forward data packets but also send their own data packets, the number of data packets to be sent increases as described above as one gets closer to the radio access point AP, so that the radio stations close to the radio access point AP require a greater amount of transmission resources than the radio stations which are at a greater distance from the radio access point AP. As this cannot be realized when a pure CASM/CA method is used, the situation arises that the radio stations close to the radio access point AP can no longer forward all the data packets they receive, so that a loss of data packets occurs. In this case, radio stations further away from the radio access point AP send a greater number of messages than can be forwarded by the radio stations close to the radio access point AP.

To avoid the loss of data packets, in accordance with the invention radio stations on the path inform their predecessors, i.e. those radio stations from which they receive data packets, about the maximum transmission resource access rate which they should use. This maximum access rate is determined in such a way that the largest possible number of data packets can be transmitted to the radio access point AP without bottlenecks arising at the radio stations close to the radio access point AP.

The term access rate does not refer to the data transmission rate determined from the rate of successful accesses, but rather to the rate at which a radio station attempts or is permitted to attempt, as applicable, to access the transmission resources. The access rate differs from the data transmission rate because collisions can occur when there are simultaneous accesses from several radio stations, so that in this case not all of the accesses are successful. A particular access rate can be realized in that, depending on the access rate determined, a certain length of time is prescribed for a radio station, for which it must wait before being permitted to access the transmission medium. This length of time is, for example, a minimum at the maximum transmission rate of 1, or 100%, as applicable. The specific length of time and the nature of the access to the transmission medium can be determined in accordance with methods which are known per se. It is thus possible, for example, to introduce into the pure CSMA/CA method, in which all the radio stations use the maximum access rate, an appropriate waiting time before the check is made as to whether the transmission medium is occupied.

It is assumed that initially all the radio stations access the transmission resources at the maximum access rate. It is further assumed that the radio stations K1, K2 and K3 generate data packets at such a rate that, even if the maximum access rate is used, at any point in time they always have data packets of their own which are to be sent.

In the second line of FIG. 1, radio station K1 sends a message RATE:1, by which it informs radio station K2 that it is currently using a maximum possible data transmission rate of 1 or 100%, as applicable, for sending data packets. Here, the message RATE:1 can take the form of a stand-alone message or can be a component of another data packet sent by the radio station K1.

After it receives the message RATE:1, the radio station K2 determines the access rate which it should use as ⅔, because it receives one data packet from the radio station K1, generates one data packet of its own, and hence in total sends 2 data packets. Along the path as far as radio station K2, three messages should be sent per time unit. For one of these message transmissions, the radio station K1 must access the transmission medium, and for two of the message transmissions the radio station K2 must do so. Hence it would be advantageous if the radio station K1 uses an access rate of ⅓ and the radio station K2 an access rate of ⅔. Hence, the radio station K2 will no longer use the maximum data rate of 1 for sending data packets, but ⅔. Radio station K2 sends a message RATE:⅔ by which it informs the radio station K3 that it is currently using an access rate of ⅔ for sending data packets. Here, the message RATE:⅔ can take the form of a stand-alone message or can be a component of another data packet sent by the radio station K2.

Radio station K2 determines the maximum access rate to be used by radio station K1 as ⅓, and uses a message MAXRATE:⅓ to inform radio station K1 about this maximum access rate which it is to use. The message MAXRATE:⅓ can take the form of a stand-alone message. However, it is advantageous if the message MAXRATE:⅓ is contained in an acknowledgement (ACK) message, which the radio station K2 sends back to the radio station K1 on receipt of a data packet from radio station K1. Radio station K1 then regulates its access rate for the sending of data packets to the radio station K2 in such a way that it conforms to the maximum access rate of ⅓ which it is to set.

As a result of the contents of the message RATE:⅔ from radio station K2, radio station K3 knows that on the path as far as radio station K3 three data packets will be sent. A first data packet is sent by the radio station K1, and two data packets are sent by radio station K2. As radio station K3 sends a data packet of its own in addition to the data packets received from radio station K2, a total of six messages are sent on the path between radio station K1 and the radio access point AP, indicated by the six arrows in the top part of FIG. 1. In order to avoid collisions between these message transmissions, which are made at the same frequency, the message transmissions should not take place simultaneously. Because the radio station K3 is responsible for three of the six messages which are to be sent per time unit, it determines its access rate as 3/6, and informs the radio access point AP of this by a message RATE: 3/6.

As the radio access point AP is the end point of the path shown in FIG. 1, the radio access point AP does not need to be notified about the access rate currently being used by the radio station K3. However, such a notification is of interest, for example for regulating the access rates, if the radio access point forwards messages received from the radio station K3 to another radio station. In this case, the path shown in FIG. 1, between the radio station K1 and the radio access point AP, represents only a part of a longer path. Furthermore, it is logical to notify the radio access point AP about the access rate currently being used by the radio station K3 when the radio access point AP is a component of several paths. In this case, the radio access point AP can determine the access rates which may be used by the radio stations, which are neighboring to it on the various paths, without an overload occurring on the radio access point AP, or interference occurring between messages on the various paths, as applicable. Thus, for example, after receiving the message RATE: 3/6 from radio station K3, the radio access point AP can reply to radio station K3 that the latter should use a lower access rate than 3/6.

Furthermore, the radio station K3 determines the maximum access rate to be used by radio station K2 as 2/6, because the radio station K2 has to handle the sending of two of the six messages which must be dealt with per time unit, and informs radio station K2 about this with the message MAXRATE: 2/6. As described above, it is advantageous if the message MAXRATE: 2/6 is incorporated into an acknowledgement message from radio station K3 to radio station K2. The radio station K2 then regulates its radio resource access rate so that it assumes the value 2/6.

After receiving the message MAXRATE: 2/6, radio station K2 determines the maximum access rate to be used by radio station K1 as ⅙, because the radio station K1 has to handle the sending of one of the six messages which must be dealt with per time unit, and informs radio station K1 about this with the message MAXRATE:⅙. Radio station K1 then uses the access rate ⅙ for sending its data packets.

The lowest part of FIG. 1 indicates the access rates which result from the iterative calculation method described. Radio station K1 accesses the transmission resources at a rate of ⅙, radio station K2 at a rate of 2/6 and radio station K3 at a rate 3/6.

The example outlined so far relates to the situation in which the radio stations K1, K2 and K3 generate their own data packets at roughly the same rate. However, the method can be applied in an analogous way to the situation in which the radio stations K1, K2 and K3 have different rates of generation for their own data packets. If, for example, the radio station K1 were to generate twice as many data packets per unit time as the radio station K2, radio station K2 in the third line of FIG. 1 would then determine its own access rate as ⅗, and the maximum access rate to be used by radio station K1 as ⅖. On the assumption that radio station K3 generates exactly as many data packets per unit time as radio station K2, radio station K3 would then correspondingly determine its own access rate as 4/9 and the maximum access rate to be used by the radio station K2 as 3/9. This would then give the maximum access rate to be used by radio station K1 as 2/9.

However, it is also possible to apply the method described on the assumption that all the radio stations on the path have the same rate of generation for their own data packets. In this case, the radio stations are thus granted a certain rate of generation and correspondingly, in accordance with the method described, a certain access rate, irrespective of their actual generation rate. This results in a fair sharing of the radio resources between the radio stations. Each of the radio stations, K1, K2 and K3 on the path then communicates to the radio access point AP the same number of messages per unit time. The fact that a radio station has a higher generation rate for its own packages can be allowed for, for example, by the owner of a radio station paying, on the basis of a QoS Agreement, for being granted a higher access rate in accordance with the higher generation rate. In addition, or alternatively, after the access rates have been determined for all the radio stations on the path, the access rates can be reduced for those radio stations which generate fewer data packets than corresponds to the access rates determined for them, and correspondingly the access rates determined can be increased for radio stations which generate more data packets than correspond to the access rates determined for them.

In the situation in which a radio station receives from several other radio stations data packets which are to be forwarded to the radio access point AP, the method described can again be applied in an analogous way. Consider the situation in which the radio station K2 has data packets from two radio stations K1 and K12 to forward to the radio access point AP. Assume in addition that the radio stations K11, K12, K2 and K3 generate data packets of their own at the same rates. In this case, the radio station K2 in the third line of FIG. 1 would determine its own access rate as ⅗, because it receives one data packet each from the radio stations K11 and K12 and sends one data packet of its own, and the maximum access rate to be used by each of the radio stations K11 and K12 as ⅕. Correspondingly, the radio station K3 would determine its own access rate as 4/9, and the maximum access rate to be used by the radio station K2 as 3/9. This would then give the maximum access rate to be used by each of the radio stations K11 and K12 as 1/9.

The access rates shown in the lowest line of FIG. 1 are optimal in respect of the fairness of the resource distribution provided that the make up of the path does not change. If the mobility of the radio stations prompts a rerouting of the path via other radio stations, then the access rates will be redetermined in accordance with the method described above.

The method described ensures fairness between the radio stations, because the data packets from different radio stations have the same probability of reaching the radio access point AP, regardless of how far the radio station is from the radio access point AP. Because the method described avoids the discarding of data packets by radio stations close to the radio access point, the total number of data packets which reach the radio access point by forwarding increases by comparison with the situation in which each radio station uses the maximum access rate of 1.

While the path considered in FIG. 1 includes only 4 radio stations, the method can also be applied in an analogous way to longer paths. The method described can be applied to all IEEE 802.11 standards such as, for example, to the QoS (Quality of Service) protocol IEEE 802.11e. But the method in accordance with the invention can also be used in the context of other transmission methods and protocols.

The structure of the radio station K3 is shown schematically in FIG. 2. The TRANSMIT DATA facilities enable radio station K3 to send its own data packets, and ones which are to be forwarded. Data about a station's own access rate and the maximum access rates to be used by other radio stations can be inserted into data packets and sent using the TRANSMIT RATES facilities. Data about the access rates currently being used by other radio stations is detected by the RECEIVE RATES facilities, and is passed over to the CALCULATE RATES facilities, which carry out the determination of the access rates to be used by the station itself and the access rates to be used by other radio stations. The link to the TRANSMIT RATES facilities enables data about the access rates which have been determined to be passed on to other radio stations.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method for communicating by radio in a radio communication system having a plurality of radio stations, comprising:
transmitting messages over a path from a first radio station to a second radio station via a set of the radio stations forwarding the messages, at least one intermediate radio station in the set of the radio stations sending a first signaling message to a first neighboring radio station along the path towards the first radio station, the first signaling message including first data about a maximum transmission resource access rate to be used for sending the messages via the set of the radio stations.

2. A method in accordance with claim 1, further comprising receiving, by the at least one intermediate radio station before sending the first signaling message, a second signaling message from the first neighboring radio station with second data about a first transmission resource access rate currently being used by the first neighboring radio station for transmitting messages to the first neighboring radio station.

3. A method in accordance with claim 2, further comprising determining, by the at least one intermediate radio station, the maximum transmission resource rate based on the second data, a first number of messages the at least one intermediate radio station must forward and a second number of messages to be sent by the at least one intermediate radio station.

4. A method in accordance with claim 3, further comprising sending, by the at least one intermediate radio station, a third signaling message to a second neighboring radio station along the path towards the second radio station with third data about a second transmission resource access rate currently used by the at least one intermediate radio station for sending messages to the second neighboring radio station.

5. A method in accordance with claim 4, wherein the first signaling message incorporates a confirmation of receipt for one of the messages received by the at least one intermediate radio station from the first neighboring radio station.

6. A method in accordance with claim 5, further comprising sending, by the first neighboring radio station after receiving the first signaling message, a fourth signaling message to a third neighboring radio station along the path towards the first radio station, with fourth data about the maximum transmission resource access rate.

7. A method in accordance with claim 2, further comprising sending, by the at least one intermediate radio station, a third signaling message to a second neighboring radio station along the path towards the second radio station with third data about a second transmission resource access rate currently used by the at least one intermediate radio station for sending messages to the second neighboring radio station.

8. A method in accordance with claim 7, further comprising determining, by the at least one intermediate radio station, the second transmission resource access rate based on the second data, a first number of messages the at least one intermediate radio station must forward and a second number of messages to be sent by the at least one intermediate radio station.

9. A method in accordance with claim 8, wherein the first signaling message incorporates a confirmation of receipt for one of the messages received by the at least one intermediate radio station from the first neighboring radio station.

10. A method in accordance with claim 9, further comprising sending, by the first neighboring radio station after receiving the first signaling message, a fourth signaling message to a third neighboring radio station along the path towards the first radio station, with fourth data about the maximum transmission resource access rate.

11. A radio station for a radio communication system having a plurality of other radio stations, comprising:
a forwarding unit forwarding messages along a path from a first radio station included in the other radio stations to a second radio station included in the other radio stations; and
a signaling message unit creating and sending to a first neighboring radio station included in the other radio stations along the path towards the first radio station, a first signaling message with first data about a maximum transmission resource access rate to be used for sending messages to said radio station.

12. A radio station in accordance with claim 1, further comprising a receiving unit receiving a second signaling message from the first neighboring radio station with second data about a first transmission resource access rate currently being used by the first neighboring radio station for transmitting messages to the first neighboring radio station.

13. A radio station in accordance with claim 12, wherein said signaling message unit determines the maximum transmission resource rate based on the second data, a first number of messages said radio station must forward and a second number of messages to be sent by said radio station.

14. A radio station in accordance with claim 13, wherein said signaling message unit further sends a third signaling message to a second neighboring radio station included in the other radio stations along the path towards the second radio station with third data about a second transmission resource access rate currently used by said radio station for sending messages to the second neighboring radio station.

15. A radio station in accordance with claim 14, wherein the first signaling message incorporates a confirmation of receipt for one of the messages received by said radio station from the first neighboring radio station.

16. A radio station in accordance with claim 12, wherein said signaling message unit further sends a third signaling message to a second neighboring radio station included in the other radio stations along the path towards the second radio station with third data about a second transmission resource access rate currently used by said radio station for sending messages to the second neighboring radio station.

17. A radio station in accordance with claim 16, wherein said signaling message unit determines the second transmission resource access rate based on the second data, a first number of messages said radio station must forward and a second number of messages to be sent by said radio station.

18. A radio station in accordance with claim 17, wherein the first signaling message incorporates a confirmation of receipt for one of the messages received by said radio station from the first neighboring radio station.
